(19) United States
(12) Patent Application Publication
(10) Pub. No.: US 2023/0195899 A1
(43) Pub. Date: Jun. 22, 2023

(54) METHOD AND APPARATUS FOR IMPROVED SECURE ACCELERATOR FIRMWARE BOOT-UP PROCESS

(71) Applicant: Intel Corporation, Santa Clara, CA (US)

(72) Inventors: Naveen LAKKAKULA, Chandler, AZ (US); John J. BROWNE, Limerick (IE); Laurent COQUEREL, Limerick (IE); Fei Z. WANG, Shannon (IE)

(21) Appl. No.: 18/109,837

(22) Filed: Feb. 14, 2023

(51) Int. Cl. G06F 21/57; G06F 21/44; G06F 9/4401

(52) U.S. Cl. CPC G06F 21/572; G06F 21/575; G06F 21/44; G06F 9/4405; G06F 2221/033

(57) ABSTRACT

An apparatus is described. The apparatus includes a plurality of processing cores and at least one accelerator within a semiconductor chip package. The accelerator is to offload at least one task from the processing cores after boot-up of the processing cores and the accelerator. The accelerator is also to perform authentication of firmware during the boot-up. The firmware is to execute on one of the at least one accelerator.

### BACKGROUND OF THE INVENTION

As information processing and management continues to depend more and more on semiconductor chip based computing and networking systems, designers of such systems are continually seeking ways to ensure that the systems operate in a secure fashion.

### BRIEF DESCRIPTION OF THE DRAWINGS

FIGS. 1a and 1b depict a chip and an authentication and authorization process;

FIG. 2 shows an improved authentication and authorization process;

FIG. 3 shows an improved chip that can perform the authentication and authorization process of FIG. 2;

FIG. 4 shows a high performance computing environment;

FIGS. 5a and 5b show high level and more detailed level views of an IPU, respectively.

### DETAILED DESCRIPTION

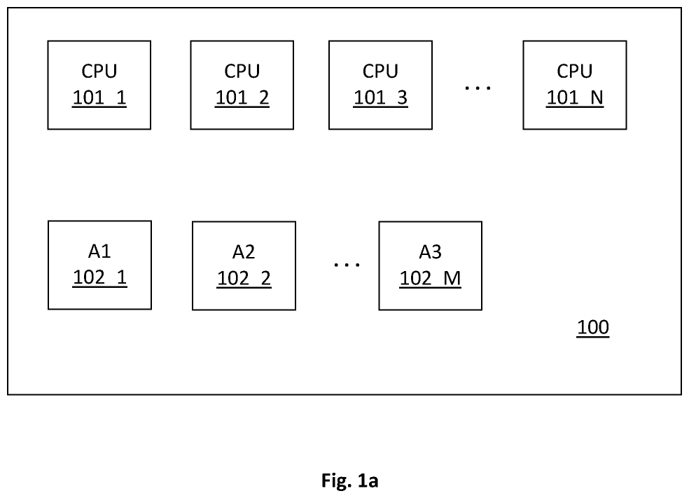

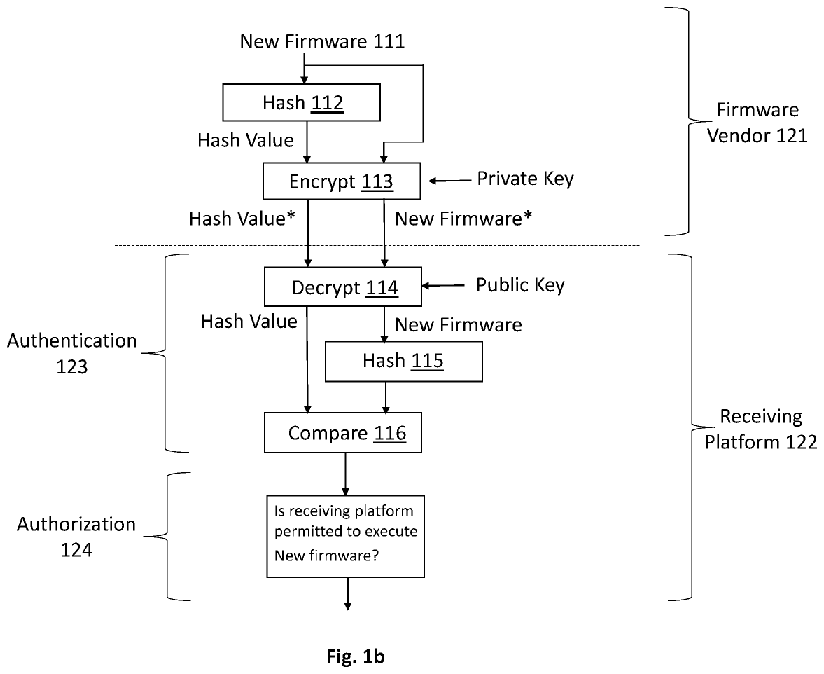

FIG. 1a depicts a complex semiconductor chip 100 such as a multi-core general purpose processor or infrastructure processing unit (IPU). As observed in FIG. 1, the chip 100 includes a plurality of general purpose processing cores 101_1 through 101_2 and one or more acceleration blocks 102_1 through 102_N.

An acceleration block 102 includes circuitry to perform dedicated, often numerically intensive task(s) and/or task(s) that are frequently relied upon during normal runtime such as any of compression/decompression, encryption/decryption, digital signal processing, image processing, graphics processing, network protocols, storage protocols, chains thereof (e.g., chained compression and encryption), etc. The integration of the acceleration block(s) 102 on the chip allows the chip 100 to perform these functions more efficiently in dedicated hardware rather than through the execution of program code on the processing cores 101.

An acceleration block 102 typically has associated firmware program code that is executed by one of the general purpose processing cores 102 (e.g., so that higher level application software programs can invoke usage of the accelerator) and/or an embedded processor/controller within the acceleration block 102. The firmware program code typically performs high level control/oversight functions for the acceleration block 102.

Over the course of the chip's lifetime, an acceleration block's firmware is often upgraded, e.g., to improve the accelerator's performance and/or functionality, and/or, remove or reduce security exposures that were discovered in a prior version of the firmware. The new firmware is ideally installed in a secure fashion.

FIG. 1b shows a traditional installation process for new firmware. As observed in FIG. 1b, after new firmware 111 has been constructed by a firmware vendor 121, the firmware vendor performs a hash 112 on the content of the new firmware (e.g., its program code instructions) to produce a hash value and then encrypts 113 the hash value using the firmware vendor's private key (the new firmware can also be encrypted as observed in FIG. 1b).

The new firmware and encrypted hash value (hash value*) are then sent to a system with a semiconductor chip having the acceleration block whose firmware is to be upgraded (replaced) with the newer firmware (the receiving platform 122). The receiving platform 122 then proceeds to execute authentication and authorization processes 123, 124 for the firmware.

The authentication process 123 confirms to the receiving platform 122 that the proper firmware vendor 121, and not an imposter, sent the newly received firmware. Here, the receiving platform 122 decrypts 114 the encrypted hash value using the appropriate vendor's public key which produces the original hash value that was created by the firmware vendor. A hash 115 is also performed the content of the newly received firmware. If the decrypted hash received from the firmware vendor matches 116 the locally calculated hash, the newly received firmware is confirmed as having been sent from the appropriate firmware vendor 121.

The authorization process 124 then proceeds to determine if the acceleration block is authorized to execute the new firmware. For example, if the new firmware includes a new function that customers are to pay an additional amount for, the acceleration block will be authorized to execute the firmware only if the owner of the receiving platform 122 has paid for the upgrade. The authorization process 124 typically entails invoking a table or list that identifies which firmware versions the acceleration block is authorized to execute. If the firmware passes both the authentication and authorization processes 123, 124 the firmware is loaded and executed by the acceleration block.

During each subsequent boot-up of the system (e.g., from a reset or power off-on sequence), the authentication and authorization processes 123, 124 are repeated by the receiving platform 114 to ensure that the correct firmware is being loaded for the acceleration block during the boot process. Boot-up is generally understood to be a computer initialization sequence in which the computer operates according to a lower level program and/or program structure (e.g., Unified Extensible Firmware Interface (UEFI), BIOS) before the computer's operating system is loaded and operational. A principle responsibility of boot-up is to initialize hardware components with their respective firmware.

A problem, referred to as a “roll-back” attack, can prevent an acceleration block from executing its latest approved firmware version. Here, the malicious attack causes an older version of the firmware to be loaded rather than the most recently approved version of the firmware.

Unfortunately, in various platforms, the authentication and authorization processes 123, 124 do not flag the problem because the older version of the firmware passes both the authentication process 123 (the older version of the firmware was provided by the correct vendor) and the authorization process 124 (the acceleration block is authorized to execute the older version of the software).

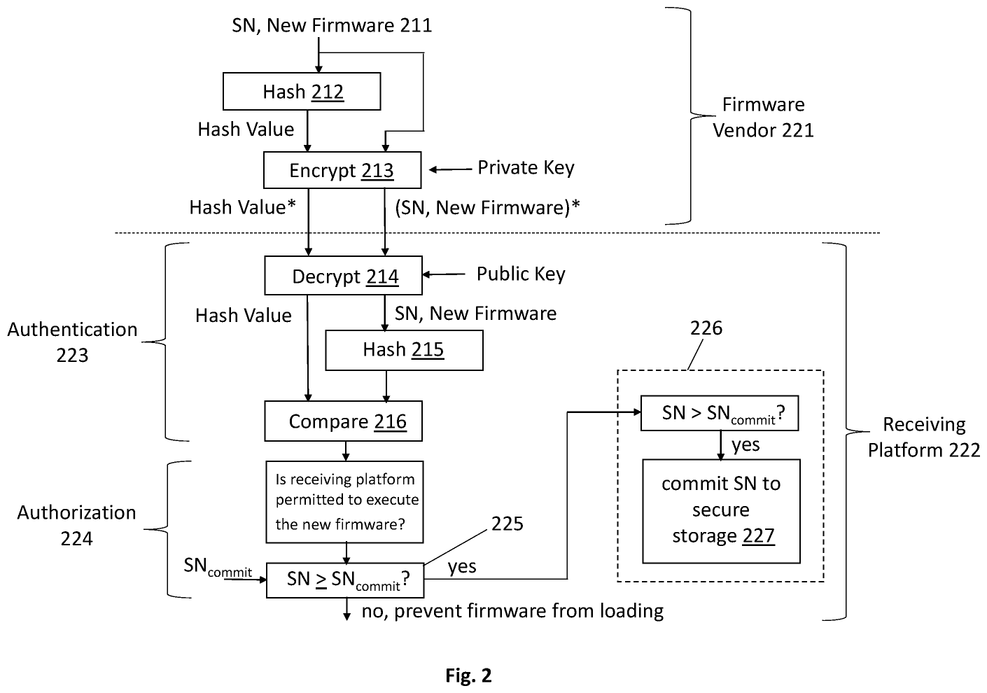

A solution, as observed in FIG. 2, is to incorporate the firmware version number (also referred to as a firmware sequence number (SN), or, more generally, as a version identifier) into the authentication and authorization 224 processes 223, 224. In the improved loading process of FIG. 2, the loading process raises a flag or otherwise prevents the loading of firmware whose SN is less than the SN of the firmware that has been most recently committed SN for the acceleration block 225. For example, if an acceleration block is committed to execute firmware having SN=4 and a rollback attack causes the loading of firmware having SN=3, the improved secure firmware loading process will raise a flag or otherwise prevent loading because the SN of the firmware being loaded (3) is less than the SN that has been committed for the acceleration block.

As observed in FIG. 2, when a new version of firmware having higher SN is constructed at the firmware vendor end, the higher SN is combined with (e.g., appended to) the content of the new firmware code 211 and a hash 212 is performed on the combination of the higher SN and new firmware code 211. The resulting hash value is then encrypted 213 with the firmware vendor's private key (as observed in FIG. 2, the new firmware and appended SN can also be encrypted 213). The encrypted hash value and new firmware with higher SN are then sent to a receiving platform 222.

At the receiving platform 222, in various embodiments, a bifurcated authentication/authorization process 223, 224 and SN commit process 226 is performed. Here, when a first/initial attempt is made to load a new instance of firmware having higher SN than the SN that has been committed for the acceleration block 225, 226, the receiving platform commits the higher SN to the acceleration block as part of the initial firmware loading process 227. Subsequent attempts to load the acceleration block's firmware (e.g., in response to subsequence resets, power off-on sequences, etc.) will then compare 225 the SN of the firmware being loaded to the SN that has been committed for the accelerator.

For the authentication process 223, the encrypted hash value is decrypted 214 with the firmware vendor's public key which produces an unencrypted hash value (which includes the SN of the new firmware). The newly received firmware content and SN combination are also hashed 215. If the resulting hash value matches the unencrypted hash value, the receiving platform 222 recognizes that the new firmware and corresponding SN were actually sent by the firmware vendor (authentication of the firmware vendor is verified).

The authorization process 224 then proceeds to determine whether the acceleration block has permission to execute the newly updated firmware (authorization is performed). Here, the decrypted hash value is used as an identifier by the authorization process for the new firmware version. The authorization process checks (e.g., against a table) that the accelerator has permission to execute firmware having the decrypted hash value identifier. If so, the authorization process compares 225 the higher SN of the new firmware to the lower SN value of the firmware that the accelerator was executing prior to the upgrade (SN_{commit}). Because the SN of the new firmware is higher than SN_{commit}, the new firmware is allowed to be loaded and executed. As such, the firmware and its encrypted hash has are stored, e.g., in the chip's local mass storage. Additionally, SN_{commit} is updated to the higher SN of the newer firmware and committed 227 (e.g., the new SN_{commit} value is stored in secure flash memory).

Each subsequent attempt to load the acceleration block's firmware (e.g., upon each boot-up sequence after a reset, power off-on sequence, etc.) freshly authenticates 223 and authorizes 224 the firmware. That is, the firmware and encrypted hash are read from mass storage, the encrypted hash is decrypted 214 and a hash 215 is performed on the firmware. Here, if a rollback attack attempts to replace the newer version of the firmware with an older version of the firmware, the hash value that is generated by the hash 215 will not match the decrypted hash because the hash values are calculated from different versions of firmware.

By contrast, if a rollback attack alternatively attempts to load an older version of the firmware with its corresponding lower SN, the authorization process 224 will raise a flag or otherwise prevent execution of the older firmware 225 because the SN of the firmware being loaded is less 225 than the SN_{commit} value that was committed for the acceleration block.

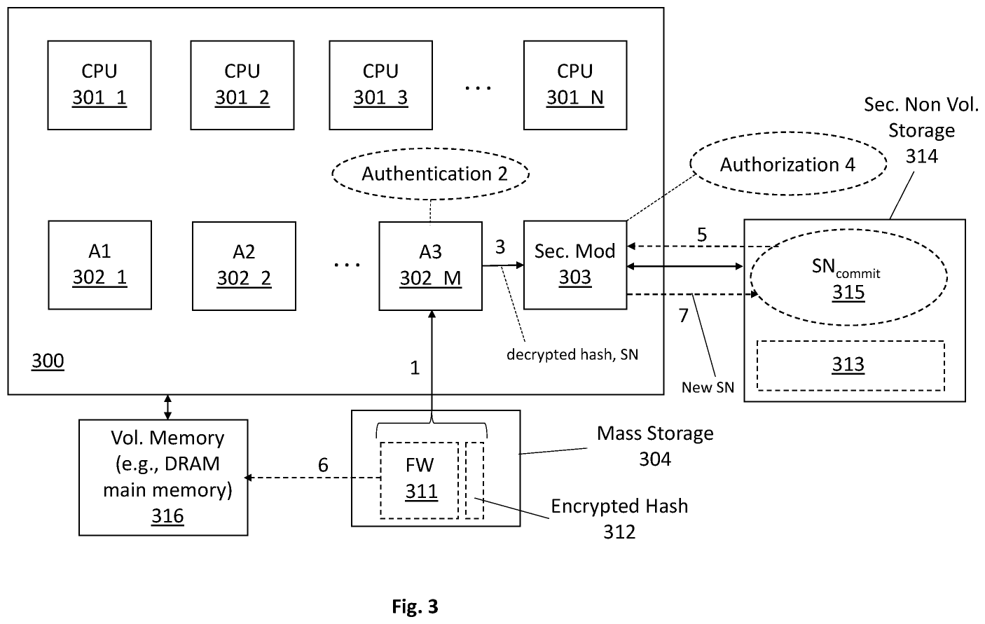

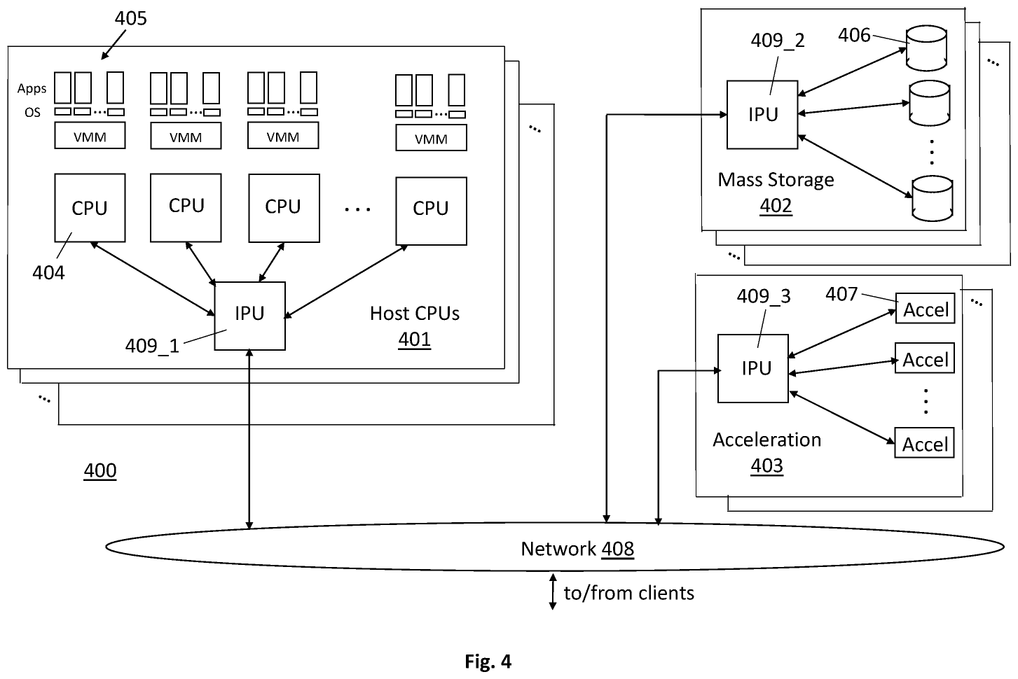

FIG. 3 shows a semiconductor chip that can perform the above described firmware loading processes for a receiving platform. In the particular implementation of FIG. 3, an acceleration block (e.g., acceleration block 302_M in FIG. 4) performs authentication and a hardware security module 303 that is integrated on the chip 300 performs authorization.

Here, in various further embodiments, the acceleration block 302_M is an encryption/decryption acceleration block that naturally includes hash and/or decryption logic circuitry to perform hash calculations and encryption/decryption during nominal runtime (e.g., for outgoing/incoming network packets and/or units of information being written/read to/from mass storage 304). Such logic circuitry is repurposed to perform the decryption 214 and hash 215 functions for authentication 223 during the boot-up process.

As such, in the implementation of FIG. 3, during boot-up, the firmware 311 and its encrypted hash 312 are read 1 from mass storage 304 and provided to the acceleration block 302_M. The acceleration block 302_M performs authentication 2 and, upon successful authentication, passes 3 the firmware's decrypted hash value and SN value to the security module 303 (e.g., as a secure write of the information into register space of the security module 303).

The security module 303 then performs authorization 4 for the firmware using the firmware's decrypted hash value as an identifier of the firmware version and for which authorization is sought. Here, in order to perform the authorization, the security module 303 can refer to information 313 in secure non volatile storage 314 that is coupled to the security module 303. The information 313 lists (e.g. in a table) or otherwise identifies, for each acceleration block on the chip, which versions of the acceleration block's firmware the acceleration block is permitted to execute.

As part of the authorization process 4, the security module 303 reads 5 the SN_{commit} value 315 that was previously committed for the acceleration block that is to execute the firmware 311 from the secure non volatile storage 314. If the SN_{commit} value is less than or equal to the SN value of the firmware that was passed 3 to the security module after authentication, the firmware 311 is allowed to boot which includes loading 6 the firmware 311 from mass storage 304 to volatile memory 316 (e.g. the DRAM main memory for the chip 300). If the SN_{commit} value is less than the firmware's SN value, the security module 303 writes the firmware's SN value into the secure non volatile storage 314 as the new SN_{commit} value 315 for the acceleration block.

As mentioned above, in various embodiments, the acceleration block 302_M that performs the authentication 2 is nominally an encryption/decryption acceleration block (and/or compression/decompression acceleration block) that performs encryption/decryption (and/or compression/decompression, such as chained compression and encryption and/or chained decryption and decompression) during nominal runtime of the chip 300 to encrypt/decrypt (and/or compress/decompress) network packets and/or units of information stored in mass storage 304. In combined or alternative embodiments, the acceleration block 302_M is nominally used to provide secure private key services for asymmetric private keys that are securely stored on the chip (e.g., by blown fuses) and used by software that executes on the chip's CPUs 301.

Notably, in various embodiments, the acceleration block 302_M performs authentication 2 during bootup of not only for its own firmware, but also, the firmware for the other acceleration blocks 302_1, 302_2, etc. on the chip 300 (e.g., all acceleration block firmware for the chip is authenticated by acceleration block 302_M). The acceleration block 302_M can also perform firmware authentication 2 for other functional blocks within the chip 300 other than one of the accelerators (e.g., power management firmware that is executed by an embedded controller within the chip or one or more of the processing cores 301).

The secure non volatile memory 314 can be one or more external flash chips that are/is coupled to the chip 300 (but, e.g., are within the same semiconductor chip package as the chip 300). Alternatively, the secure non volatile memory 304 can be integrated on the chip 300 (e.g., as a resistive cell, three-dimensional crosspoint memory formed amongst the chip's wiring above the chip substrate). The mass storage 304 can be implemented, e.g., as one or more solid state drives (SSDs) and/or hard disk drives that are communicatively coupled to the chip.

The chip's volatile (e.g., DRAM) memory 316 can be implemented as one or more memory modules that are plugged into the circuit board that the chip is mounted upon (e.g., one or more dual in-line memory modules (DIMMs), stacked memory chip modules) and/or volatile memory chips that are stacked on the chip 300. The chip 300 can also include a peripheral hub controller (PCH) to communicate to mass storage 304 and a memory controller to communicate with volatile memory 314. For ease of drawing neither of these units are depicted in FIG. 3. In various embodiments, the firmware vendor public keys used for authentication are securely stored on the chip 300 with blown fuses, e.g., in the peripheral control hub.

The chip's primary boot-up software which, e.g., executes on one of the CPUs 301 (and/or an embedded controller on the chip 300) oversees/controls the improved firmware loading process. For example, such primary boot-up software sends commands to the chip hardware 300 to perform any/all of the processes 1, 2, 3, 4, 5, 6, 7 described above with respect to FIG. 3.

The improved chip 300 can be any of a number of different kinds of complex chips (e.g., system-on-chips (SOCs) such as, to name a few, a multicore general purpose CPU processor, a specific purpose processor or infrastructure processing unit.

A new high performance computing environment (e.g., data center) paradigm is emerging in which “infrastructure” tasks are offloaded from traditional general purpose “host” CPUs (where application software programs are executed) to an infrastructure processing unit (IPU), data processing unit (DPU) or smart networking interface card (SmartNIC), any/all of which are hereafter referred to as an IPU.

Networked based computer services, such as those provided by cloud services and/or large enterprise data centers, commonly execute application software programs for remote clients. Here, the application software programs typically execute a specific (e.g., “business”) end-function (e.g., customer servicing, purchasing, supply-chain management, email, etc.). Remote clients invoke/use these applications through temporary network sessions/connections that are established by the data center between the clients and the applications.

In order to support the network sessions and/or the applications' functionality, however, certain underlying computationally intensive and/or trafficking intensive functions (“infrastructure” functions) are performed.

Examples of infrastructure functions include encryption/decryption for secure network connections, compression/decompression for smaller footprint data storage and/or network communications, virtual networking between clients and applications and/or between applications, packet processing, ingress/egress queuing of the networking traffic between clients and applications and/or between applications, ingress/egress queueing of the command/response traffic between the applications and mass storage devices, error checking (including checksum calculations to ensure data integrity), distributed computing remote memory access functions, etc.

Traditionally, these infrastructure functions have been performed by the host CPUs “beneath” their end-function applications. However, the intensity of the infrastructure functions has begun to affect the ability of the host CPUs to perform their end-function applications in a timely manner relative to the expectations of the clients, and/or, perform their end-functions in a power efficient manner relative to the expectations of data center operators. Moreover, the host CPUs, which are typically complex instruction set (CISC) processors, are better utilized executing the processes of a wide variety of different application software programs than the more mundane and/or more focused infrastructure processes.

As such, as observed in FIG. 4, the infrastructure functions are being migrated to an infrastructure processing unit. FIG. 4 depicts an exemplary data center environment 400 that integrates IPUs 407 to offload infrastructure functions from the host CPUs 404 as described above. Here, again, the improved chip 300 of FIG. 3 can be a host CPU (e.g., general purpose processor) 404, a specific purpose processor 407 or an IPU 409.

As observed in FIG. 4, the exemplary data center environment 400 includes pools 401 of host CPUs 404 that execute the end-function application software programs 405 that are typically invoked by remotely calling clients. The data center also includes separate mass storage pools 402 and application acceleration resource pools 403 to assist the executing applications.

Here, for instance, the mass storage pools 402 includes numerous storage devices 406 (e.g., solid state drives (SSDs)) to support “big data” applications, database applications or even remotely calling clients that desire to access data that has been previously stored in a mass storage pool 402. The application acceleration resource pool 403 includes numerous specific processors (acceleration cores) 407 (e.g., GPUs) that are tuned to better perform certain numerically intensive, application level tasks (e.g., machine learning of customer usage patterns, image processing, etc.). In a common scenario, applications 405 running on the host CPUs 404 access a mass storage pool 402 to obtain data that the applications perform operations upon, and/or, invoke an acceleration resource pool 403 to “speed-up” certain numerically intensive functions.

The host CPU, mass storage and acceleration pools 401, 402, 403 are respectively coupled by one or more networks 408. Notably, each pool 401, 402, 403 has an IPU 409_1, 409_2, 409_3 on its front end or network side. Here, the IPU 409 performs pre-configured infrastructure functions on the inbound (request) packets it receives from the network 408 before delivering the requests to its respective pool's end function (e.g., application software program 405, mass storage device 406, acceleration core 407). As the end functions send their output responses (e.g., application software resultants, read data, acceleration resultants), the IPU 409 performs pre-configured infrastructure functions on the outbound packets before transmitting them into the network 408.

Depending on implementation, one or more host CPU pools 401, mass storage pools 402, acceleration pools 403 and network 408 can exist within a single chassis, e.g., as a traditional rack mounted computing system (e.g., server computer). In a disaggregated computing system implementation, one or more host CPU pools 401, mass storage pools 402 and/or acceleration pools 403 are separate rack mountable units (e.g., a rack mountable host CPU unit, a rack mountable mass storage unit, and/or a rack mountable acceleration unit).

In various embodiments, the software platform on which the applications 105 are executed include a virtual machine monitor (VMM), or hypervisor, that instantiates multiple virtual machines (VMs). Operating system (OS) instances respectively execute on the VMs and the applications execute on the OS instances. Alternatively or combined, container engines (e.g., Kubernetes container engines) respectively execute on the OS instances. The container engines provide virtualized OS instances and containers respectively execute on the virtualized OS instances. The containers provide isolated execution environment for a suite of applications which can include, applications for micro-services.

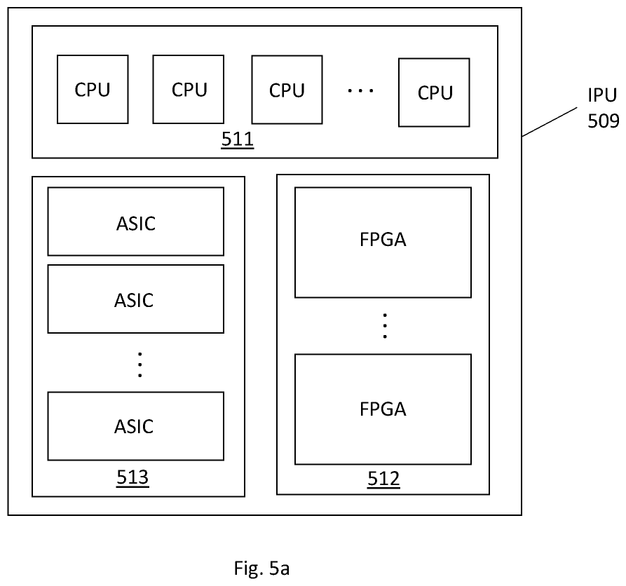

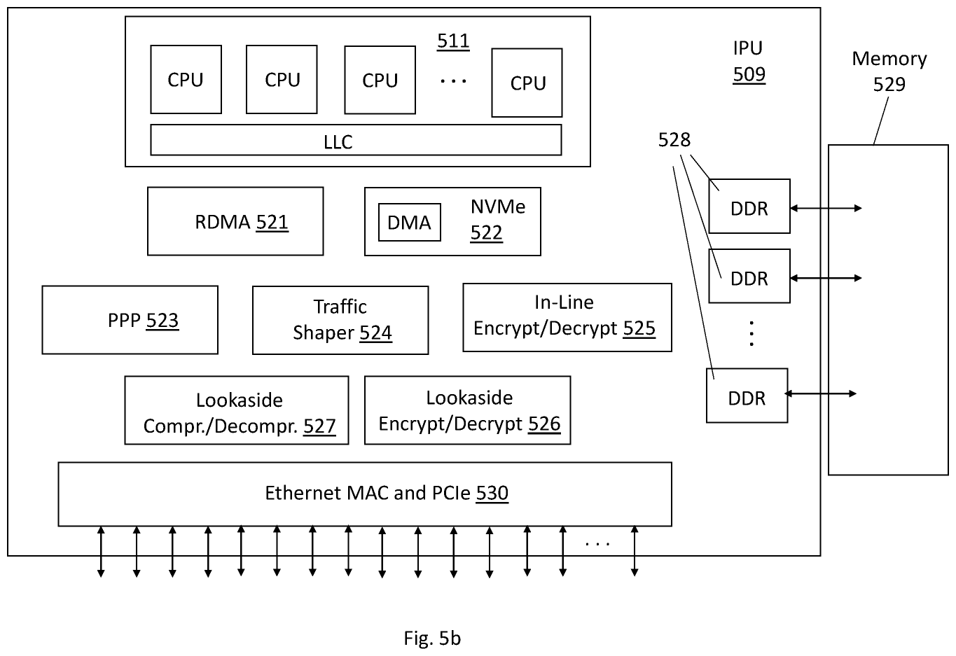

FIG. 5a shows an exemplary IPU 509. As observed in FIG. 5 the IPU 509 includes a plurality of general purpose processing cores 511, one or more field programmable gate arrays (FPGAs) 512 and one or more acceleration hardware (ASIC) blocks 513. The processing cores 511, FPGAs 512 and ASIC blocks 513 represent different tradeoffs between versatility/programmability, computational performance and power consumption. Generally, a task can be performed faster in an ASIC block and with minimal power consumption, however, an ASIC block is a fixed function unit that can only perform the functions its electronic circuitry has been specifically designed to perform.

The general purpose processing cores 511, by contrast, will perform their tasks slower and with more power consumption but can be programmed to perform a wide variety of different functions (via the execution of software programs). Here, it is notable that although the processing cores can be general purpose CPUs like the data center's host CPUs 104, in many instances the IPU's general purpose processors 511 are reduced instruction set (RISC) based processors rather than CISC based processors (which the host CPUs 104 are typically implemented with). That is, the host CPUs 104 that execute the data center's application software programs 105 tend to be CISC based processors because of the extremely wide variety of different tasks that the data center's application software could be programmed to perform.

By contrast, the infrastructure functions performed by the IPUs tend to be a more limited set of functions that are better served with a RISC processor. As such, the IPU's RISC processors can perform the infrastructure functions with noticeably less power consumption than CISC processors without significant loss of performance.

The FPGA(s) 512 provide for more programming capability than an ASIC block but less programming capability than the general purpose cores 511, while, at the same time, providing for more processing performance capability than the general purpose cores 511 but less than processing performing capability than an ASIC block.

FIG. 5b shows a more specific embodiment of an IPU. For ease of explanation the IPU of FIG. 5 does not include a FPGA blocks. As observed in FIG. 5 the IPU includes a plurality of general purpose cores and a last level caching layer for the RISC cores. The IPU also includes a number of hardware ASIC acceleration blocks including: 1) an RDMA acceleration ASIC block 521 that performs RDMA protocol operations in hardware; 2) an NVMe acceleration ASIC block 522 that performs NVMe protocol operations in hardware; 3) a packet processing pipeline ASIC block 523 that parses ingress packet header content, e.g., to assign flows to the ingress packets, perform network address translation, etc.; 4) a traffic shaper 524 to assign ingress packets to appropriate queues for subsequent processing by the IPU 509; 5) an in-line cryptographic ASIC block 525 that performs decryption on ingress packets and encryption on egress packets; 6) a lookaside cryptographic ASIC block 526 that performs encryption/decryption on blocks of data, e.g., as requested by a host CPU 104; 7) a lookaside compression ASIC block 527 that performs compression/decompression on blocks of data, e.g., as requested by a host CPU 104; 8) checksum/cyclic-redundancy-check (CRC) calculations (e.g., for NVMe/TCP data digests and/or NVMe DIF/DIX data integrity); 9) thread local storage (TLS) processes; etc.

The IPU 509 also includes multiple memory channel interfaces 528 to couple to external memory 529 that is used to store instructions for the general purpose cores 511 and input/output data for the IPU cores 511 and each of the ASIC blocks 521-526. The IPU includes multiple PCIe physical interfaces and an Ethernet Media Access Control block 530 to implement network connectivity to/from the IPU 509.

Although embodiments described above have referred to implementations where one or more accelerators and a plurality of processing cores that can invoke the accelerator(s) are integrated on a same semiconductor chip 300, 509, in other implementations, the plurality of processing cores and the accelerator(s) are implemented on different semiconductor chips. In either of these approaches, the plurality of processing cores and the accelerator(s) can be integrated into a same semiconductor chip package.

Embodiments of the invention may include various processes as set forth above. The processes may be embodied in program code (e.g., machine-executable instructions). The program code, when processed, causes a general-purpose or special-purpose processor to perform the program code's processes. Alternatively, these processes may be performed by specific/custom hardware components that contain hard wired interconnected logic circuitry (e.g., application specific integrated circuit (ASIC) logic circuitry) or programmable logic circuitry (e.g., field programmable gate array (FPGA) logic circuitry, programmable logic device (PLD) logic circuitry) for performing the processes, or by any combination of program code and logic circuitry.

Elements of the present invention may also be provided as a machine-readable medium for storing the program code. The machine-readable medium can include, but is not limited to, floppy diskettes, optical disks, CD-ROMs, and magneto-optical disks, FLASH memory, ROMs, RAMs, EPROMs, EEPROMs, magnetic or optical cards or other type of media/machine-readable medium suitable for storing electronic instructions.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. An apparatus, comprising:
a plurality of processing cores and at least one accelerator within a semiconductor chip package, the accelerator to offload at least one task from the processing cores after boot-up of the processing cores and the accelerator, the accelerator to also perform authentication of firmware during the boot-up, the firmware to execute on one of the at least one accelerator.

2. The apparatus of claim 1 wherein the at least one task includes encryption/decryption.

3. The apparatus of claim 1 wherein the at least one task includes compression/decompression.

4. The apparatus of claim 1 wherein, during the boot-up, the accelerator is to decrypt an encrypted hash of the firmware with a public key.

5. The apparatus of claim 4 wherein the public key is stored on a semiconductor chip with fuses.

6. The apparatus of claim 1 wherein the plurality of processing cores are part of a general purpose processor or a specific purpose processor.

7. The apparatus of claim 1 wherein the semiconductor chip package includes an infrastructure processing unit.

8. An apparatus, comprising:
a semiconductor chip package comprising i), ii), and iii) below:
i) a plurality of processing cores;
ii) at least one accelerator to offload at least one task from the plurality of processing cores after boot-up of the plurality of processing cores and the at least one accelerator;
iii) circuitry to prevent loading of firmware having a first version identifier that is an earlier version than a second version identifier that was previously stored for the firmware in secure non volatile storage.

9. The apparatus of claim 8 wherein the at least one accelerator is to decrypt an encrypted hash of the firmware and the first version identifier to generate the first version identifier.

10. The apparatus of claim 9 wherein the at least one accelerator is to decrypt the encrypted hash with a public key that is stored on a semiconductor chip.

11. The apparatus of claim 9 wherein the at least one accelerator is to compare the decrypted hash with another hash that is calculated from the firmware and the first version identifier.

12. The apparatus of claim 8 wherein the circuitry is integrated within a security module that is integrated on a semiconductor chip having the at least one accelerator.

13. The apparatus of claim 8 wherein the at least one accelerator is to offload encryption/decryption tasks from the plurality of processing cores.

14. The apparatus of claim 8 wherein the at least one accelerator is to offload compression/decompression tasks from the plurality of processing cores.

15. The apparatus of claim 8 wherein the at least one accelerator is to chain decryption and decompression tasks.

16. The apparatus of claim 8 wherein the plurality of processing cores are part of a general purpose processor or specific purpose processor.

17. The apparatus of claim 8 wherein the semiconductor chip package includes an infrastructure processing unit.

18. A computing system, comprising:
a) firmware stored in mass storage;
b) a version identifier for the firmware stored in secure non volatile storage;
c) a semiconductor chip package, the semiconductor chip comprising i), ii) and iii) below:
i) a plurality of processing cores;
ii) at least one accelerator to offload at least one task from the plurality of processing cores after boot-up of the plurality of processing cores and the at least one accelerator, the at least one accelerator to authenticate the firmware and determine the firmware's version identifier during the boot-up;
iii) circuitry to prevent loading of the firmware if the firmware's version identifier is an earlier version than the version identifier that is stored for the firmware in the secure non volatile storage.

19. The computing system of claim 18 wherein the at least one accelerator is to decrypt an encrypted hash of the firmware and the firmware's version identifier to generate the firmware's version identifier.

20. The computing system of claim 18 wherein the plurality of processing cores are components of a general purpose multicore processor or specific purpose processor.
